(19) United States
(12) Patent Application Publication
(10) Pub. No.: US 2024/0048203 A1
(43) Pub. Date: Feb. 8, 2024

(54) MOBILITY CLASSIFICATION AND CHANNEL STATE INFORMATION PREDICTION

(71) Applicant: Samsung Electronics Co., Ltd., Suwon-si (KR)

(72) Inventors: Tiexing Wang, Plano, TX (US); Umut Demirhan, Tempe, AZ (US); Yang Li, Plano, TX (US)

(21) Appl. No.: 18/348,266

(22) Filed: Jul. 6, 2023

Related U.S. Application Data
(60) Provisional application No. 63/395,733, filed on Aug. 5, 2022.

(51) Int. Cl. H04B 7/06

(52) U.S. Cl. CPC H04B 7/0626; H04B 7/0639; H04B 7/0632; H04B 7/0634

(57) ABSTRACT

Methods and apparatuses for mobility classification and channel state information (CSI) prediction. A method for operating a base station includes receiving, from a user equipment (UE), a channel status state information (CSI) report comprising a precoding matrix indicator (PMI), a channel quality information (CQI), and a rank indicator (RI). The method further includes identifying a CSI configuration of the UE and performing a metric smoothing operation on the PMI. The metric smoothing operation results in a smoothed PMI. The metric smoothing operation comprises a scaling function based on the RI and a discrete Fourier transform (DFT) vector length. The method further includes determining a mobility range classification of the UE based on the smoothed PMI, other metrics in the CSI feedback report, and the CSI configuration.

### CROSS-REFERENCE TO RELATED APPLICATION(S) AND CLAIM OF PRIORITY

This application claims priority under 35 U.S.C. § 119(e) to U.S. Provisional Patent Application No. 63/395,733 filed on Aug. 5, 2022. The above-identified provisional patent application is hereby incorporated by reference in its entirety.

### TECHNICAL FIELD

This disclosure relates generally to wireless communication systems. More specifically, this disclosure relates to mobility classification and channel state information (CSI) prediction.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for mobility classification and CSI prediction.

In one embodiment, a base station (BS) is provided. The BS includes a transceiver. The transceiver is configured to receive, from a user equipment (UE), a channel status state information (CSI) report comprising a precoding matrix indicator (PMI), a channel quality information (CQI), and a rank indicator (RI). The BS further includes a processor operably coupled to the transceiver. The processor is configured to identify a CSI configuration of the UE, and perform a metric smoothing operation on the PMI. The metric smoothing operation results in a smoothed PMI. The metric smoothing operation comprises a scaling function based on the RI and a discrete Fourier transform (DFT) vector length. The processor is further configured to determine a mobility range classification of the UE based on the smoothed PMI, other metrics in the CSI feedback report, and the CSI configuration.

In another embodiment, a method of operating a BS is provided. The method includes receiving, from a UE, a CSI report comprising a PMI, a channel quality information CQI, and an RI. The method further includes identifying a CSI configuration of the UE, and performing a metric smoothing operation on the PMI. The metric smoothing operation results in a smoothed PMI. The metric smoothing operation comprises a scaling function based on the RI and a DFT vector length. The method further includes determining a mobility range classification of the UE based on the smoothed PMI, other metrics in the CSI report, and the CSI configuration.

In yet another embodiment, a non-transitory computer readable medium is provided. The non-transitory computer readable medium embodies a computer program. the computer program includes computer readable program code that when executed causes at least one processing device to receive, from a UE, a CSI report comprising a PMI, a CQI, an RI; identify a CSI configuration of the UE; and perform a metric smoothing operation on the PMI. The metric smoothing operation results in a smoothed PMI. The metric smoothing operation comprises a scaling function based on the RI and a DFT vector length. The computer readable program further includes code that when executed causes the at least one processing device to determine a mobility range classification of the UE based on the smoothed PMI, other metrics in the CSI report, and the CSI configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates a block diagram for an example method of mobility classification and CSI prediction according to embodiments of the present disclosure;

FIG. 5 illustrates an example of codebook configuration according to embodiments of the present disclosure;

FIG. 6 illustrates an example result of PMI smoothing by a scaling function according to this embodiments of the present disclosure;

FIG. 7 illustrates an example of DFT codewords according to embodiments of this disclosure;

FIG. 8 illustrates an example result of a phase reordering function according to embodiments of this disclosure according to this disclosure;

FIG. 9 illustrates an example result of an unwrapping function according to embodiments of this disclosure;

FIG. 10 illustrates a block diagram for an example method of CSI prediction according to embodiments of this disclosure;

FIG. 11 illustrates a block diagram for an example method of CSI prediction evaluation according to embodiments of this disclosure;

FIG. 12 illustrates an example method for UE speed range classification according to embodiments of this disclosure;

FIG. 13 illustrates an example an example of generated features for mobility range classification according to embodiments of this disclosure according to this disclosure; and

FIG. 14 illustrates an example method of mobility classification and CSI prediction according to embodiments of the present disclosure.

### DETAILED DESCRIPTION

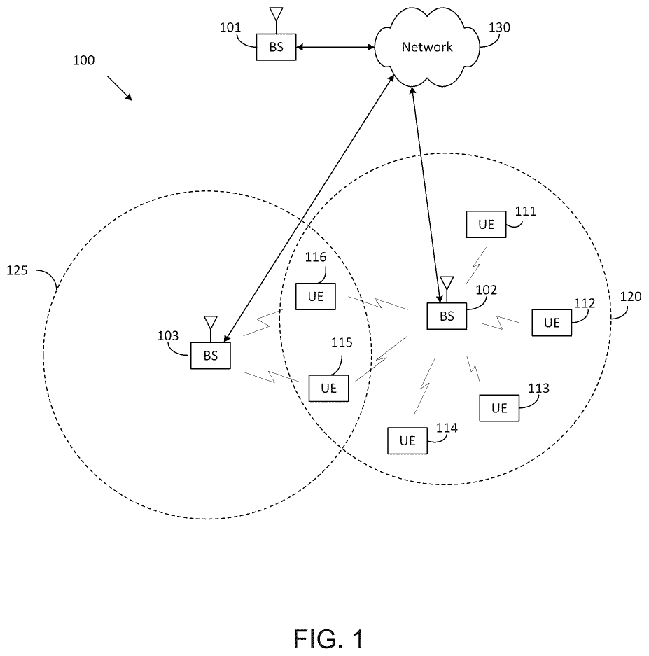

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for mobility classification and CSI prediction. In certain embodiments, one or more of the gNBs 101-103 includes circuitry, programing, or a combination thereof, to support a mobility classification and CSI prediction in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

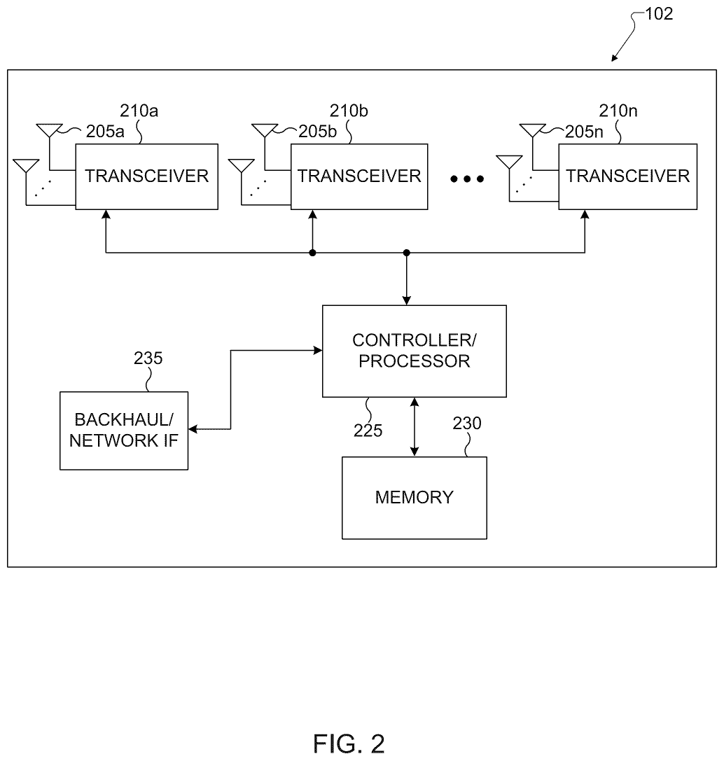

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS, and, for example, processes to support mobility classification and CSI prediction as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

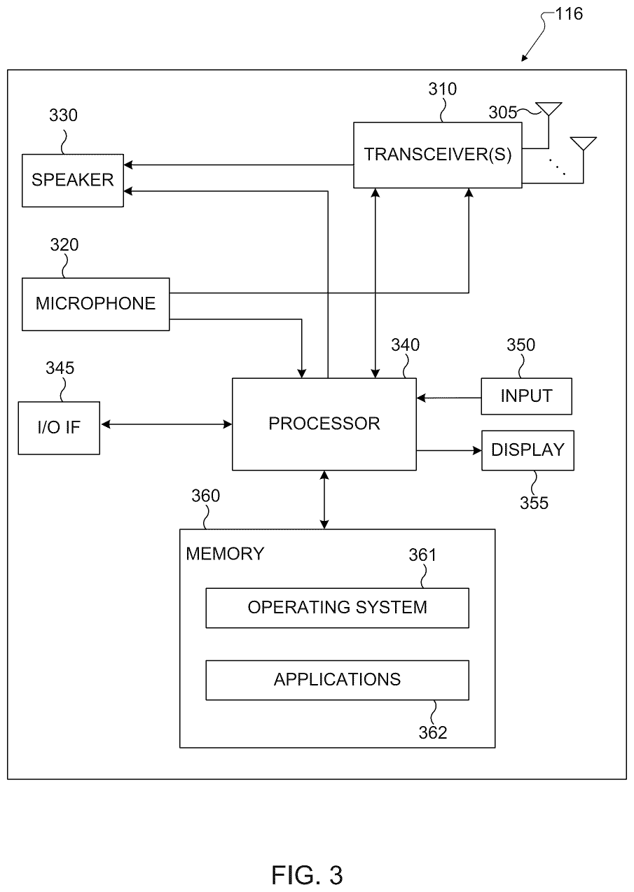

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for mobility classification and CSI prediction as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

A wireless network, such as the wireless network of FIG. 1 may generate a channel state information (CSI) report. For example, UE 111 may transmit a CSI report to BS 102. A CSI report may include one or more components such as rank indicator (RI), channel quality indicator (CQI) and precoder matrix indicator (PMI), ACK/NACK etc. PMI may refer to a quantized version of the channel between a gNB and a UE, and may be subject to channel aging due to mobility as well as quantization error.

According to embodiments of the present disclosure a CSI report may be used classify users' speed range (mobility classification), predict CSI for a refined resolution of current or future time, and select an optional CSI configuration such as a periodicity configuration of CSI-RS transmission or when to trigger aperiodic CSI-RS transmission. CSI prediction may comprise multiple components, including PMI prediction, CQI prediction and RI prediction.

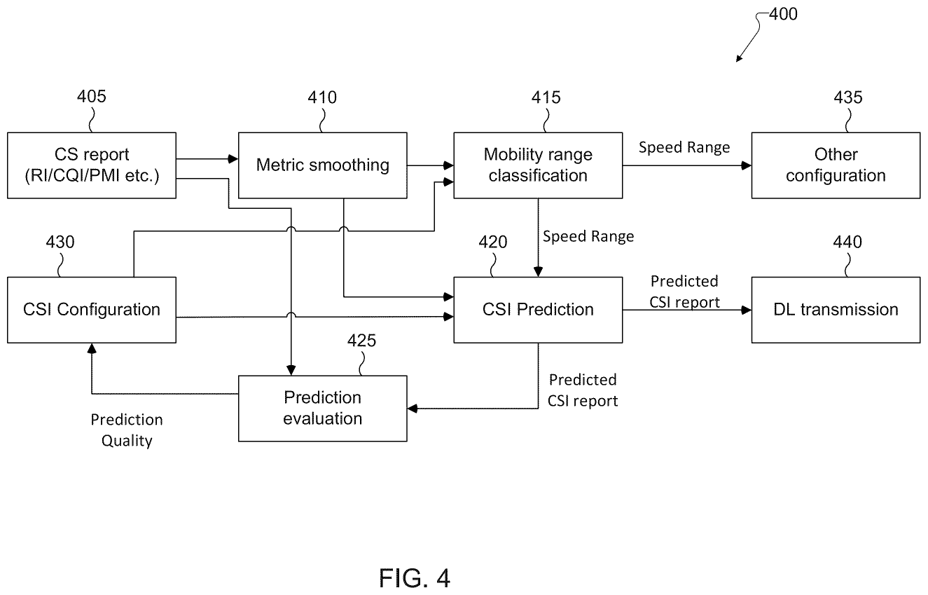

FIG. 4 illustrates a block diagram for an example method of mobility classification and CSI prediction 400 according to embodiments of the present disclosure. The embodiment of mobility classification and CSI prediction shown in FIG. 4 is for illustration only. Other embodiments of mobility classification and CSI prediction could be used without departing from the scope of this disclosure.

In the example of FIG. 4, at block 405 an apparatus, such as BS 102 of FIG. 1 may receive a CSI report. At block 415, metrics from the CSI report, such as AR, CQI, PMI, etc. may be used to perform mobility classification, and may also be used for CSI prediction at block 420. Before the information from the CSI report is used to perform mobility classification or CSI prediction, the metrics may be smoothed by a smoothing function at block 410. Furthermore, the mobility range classification may be utilized for CSI prediction in addition to the CSI metrics at block 420. Additionally, metrics from the CSI report and the CSI prediction may be used to perform a CSI prediction evaluation at block 425. At block 430 a CSI configuration may be reconfigured based on a CSI predication evaluation. At block 435, configurations may be adapted based on mobility range classification. For example, more frequent RS given UE with higher UE mobility. At block 440, downlink (DL) transmission may be based on CSI prediction. For example, precoding and link adaption may be based on CSI prediction.

Although FIG. 4 illustrates one example of mobility classification and CSI prediction, various changes may be made to FIG. 4. For example, mobility range classification and CSI prediction may be performed without metric smoothing, the CSI configuration may be reconfigured without using prediction evaluation, etc.

According to embodiments of the present disclosure PMI prediction may be used to mitigate channel aging effect and refine PMI's quantization error. PMI prediction may have a large influence over CSI prediction as PMI prediction accuracy may impact downlink beamforming performance. Under 3GPP, PMI typically comprises multiple subcomponents [i₁₁, i₁₂, i₁₃, i₂] which may correspond to the wireless metrics shown in Table 1.

TABLE 1

| PMI value | Relevant metric in wireless channels |
|---|---|
| i₁₁ | Azimuth angle |
| i₁₂ | Zenith angle |
| i₁₃ | Beam/angle group for dominant multi-paths |
| i₂ | Co-phasing for the two polarization of antenna array |

Under 3GPP, for a typical CSI report the left column values will be fed back. However, these values may not be directly inferred based on current codebook design, The physical relations between PMI value and relevant metrics in wireless channels may change depending on RI as well as codebook configuration.

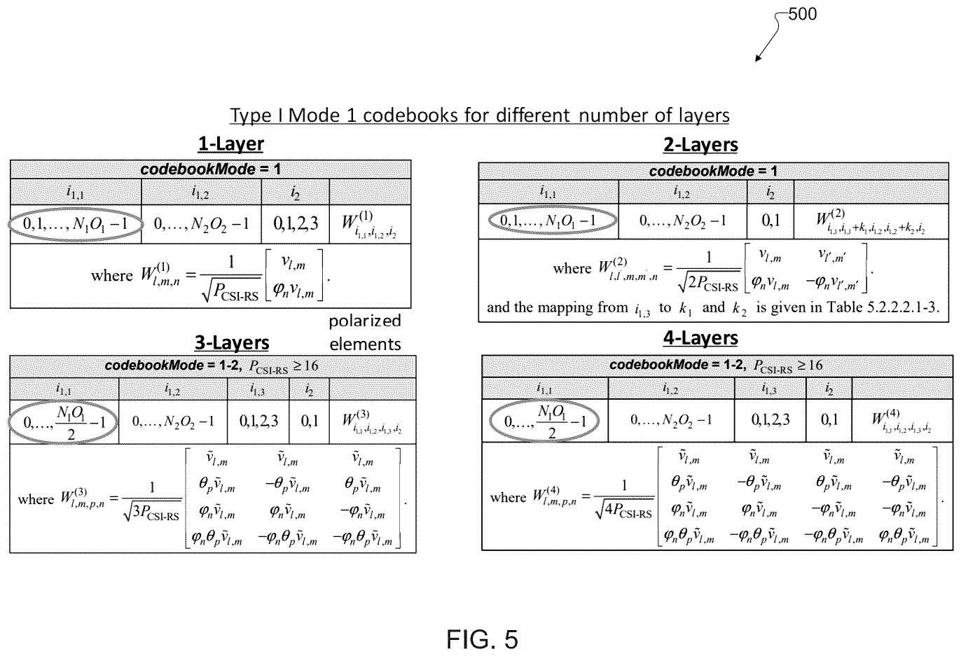

FIG. 5 illustrates an example of codebook configuration 500 according to embodiments of the present disclosure. The embodiment of codebook configuration shown in FIG. 5 is for illustration only. Other embodiments of the codebook configuration could be used without departing from the scope of this disclosure.

In the example of FIG. 5, type I mode 1 codebooks for are shown for 1, 2, 3 and 4 layers. In the example of FIG. 5, N₁ corresponds with a number of horizontal elements, N₂ corresponds with a number of vertical elements, O₁ corresponds with horizontal oversampling, and O₂ corresponds with vertical oversampling. For example, in the case where N₁=8, N₂=2, O₁=4, O₂=4 the codebooks of FIG. 5 yield 32 azimuth 8 elevation directions.

Although FIG. 5 illustrates one example of a codebook configuration, various changes may be made to FIG. 5. For example, the number of layers may change, the mode of the codebooks may change, etc.

As previously described, metrics from a CSI report may be smoothed prior to their use in mobility range classification or CSI prediction (for example, at block 410 of FIG. 4). In one example, PMI may be smoothed by a scaling function. For instance, in one embodiment, the codebook configuration (semi-statically configured) and RI (based on current feedback value) may be used to jointly build a mapping function which takes current feedback of i₁₁, i₁₂, i₁₃ to map to physical angle directions. In one embodiment of a scaling function, if Type I codebook is configured, different number of layers result in the codebooks of different sizes:

RI≤2⇒PMIi(1,1)=N₁O₁=32 elements horizontal discrete Fourier transform (DFT) vector

RI≥3⇒PMIi(1,1)=N₂O₂/2=16 elements horizontal DFT vector

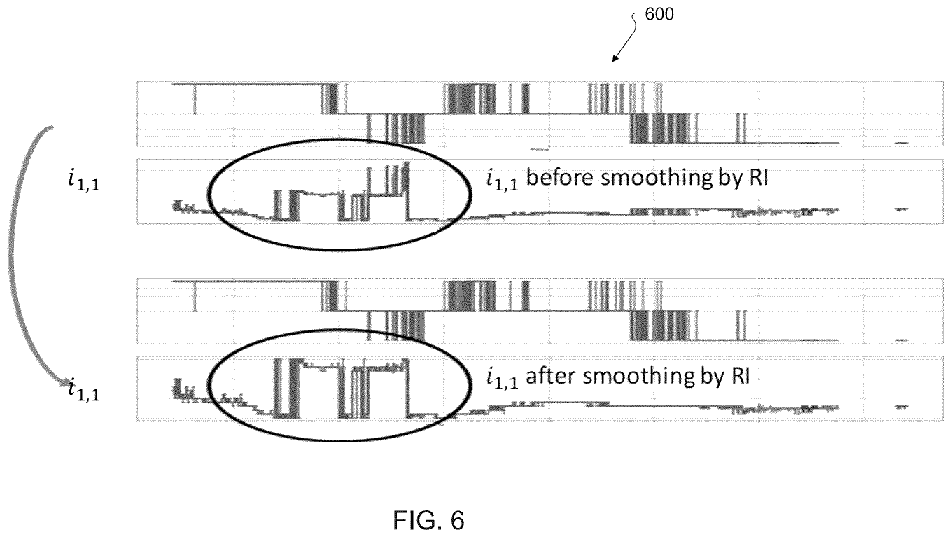

For instance, for a smooth angular indicator, PMI i(1,1) may be multiplied by 2 if RI≥3. The results of such an operation are shown in FIG. 6.

FIG. 6 illustrates an example result of PMI smoothing by a scaling function 600 according to embodiments of the present disclosure. The example result of PMI smoothing by scaling a scaling function shown in FIG. 6 is for illustration only. Other embodiments of PMI smoothing by a scaling function could be used without departing from the scope of this disclosure.

In the example of FIG. 6, Without smoothing the range of i_{1,1} depends on RI:
If RI≤2, i_{1,1}∈[0,31]
If RI≥3, i_{1,1}∈[0,15] (Can be viewed as down-sampled from [0,31]).

Although FIG. 6 illustrates one example of a result of PMI smoothing by a scaling function, various changes may be made to FIG. 6. For example, the function may be presented with different values, resulting in a different pattern on the illustration of FIG. 6.

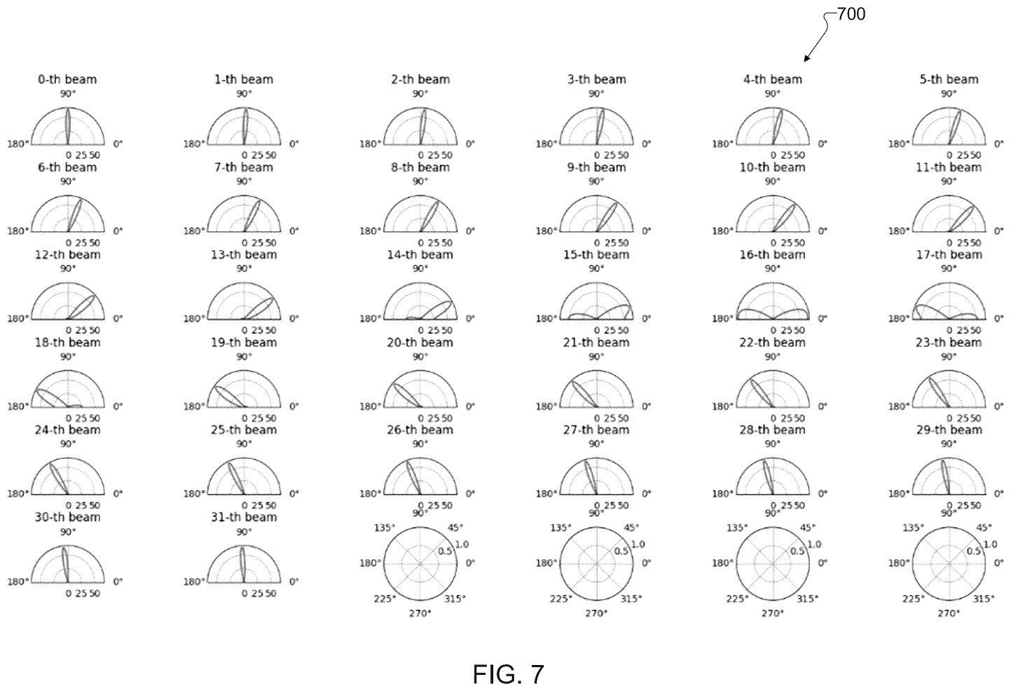

In another embodiment, the above PMI scaling function may be further smoothed by accounting for the wrap around effect of DFT codewords (a phase reordering function). In FIG. 7, different DFT codewords are plotted.

FIG. 7 illustrates an example of DFT codewords 700 according to embodiments of this disclosure. The example of DFT codewords shown in FIG. 7 is for illustration only. Other embodiments of DFT codewords could be used without departing from the scope of this disclosure.

In the example of FIG. 7, one can see that the first 16 beams cover the angles from 90 to 0, and the latter 16 beams cover the angles from 180 to 90. Therefore, one may apply an angle shift for an angular order from 180-0, i.e.,

i_1,1≥16=>i_1,1=i_1,1−16

i_1,1<16=>i_1,1=i_1,1+16

Note the large side-lobes for the beams 15-17 may cause a jump between 0-31 after the processing.

Although FIG. 7 illustrates one example of a DFT codewords, various changes may be made to FIG. 7. For example, different DFT codewords may be assigned to different angles.

In one example of a phase reordering function, i_{1,j} for j∈{1,2} may be smoothed by

$${i}_{1 , j} = \{ \begin{matrix}{i}_{1 , j} - \frac{{N}_{j} {0}_{j}}{2} & if {i}_{1 , j} \geq \frac{{N}_{j} {0}_{j}}{2} \\ {i}_{1 , j} + \frac{{N}_{j} {0}_{j}}{2} & if {i}_{1} , j < \frac{{N}_{j} {0}_{j}}{2}\end{matrix}$$

Swap the first half with the second half: 90 to 0 and 180 to 90→180 to 0.

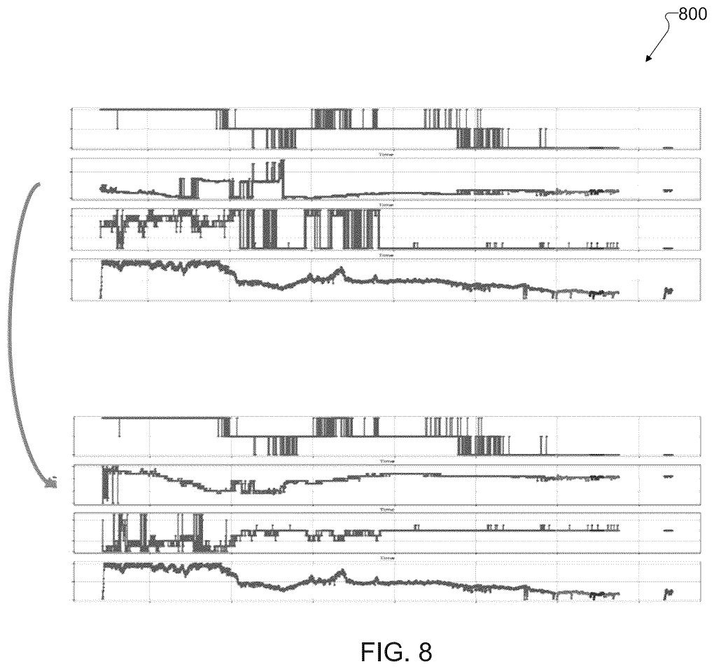

FIG. 8 illustrates an example result of a phase reordering function 800 according to embodiments of this disclosure. The example result of a phase reordering function in FIG. 8 is for illustration only. Other embodiments of a phase reordering function could be used without departing from the scope of this disclosure.

In the example of FIG. 8, the PMI smoothed result of FIG. 6 is further smoothed by a phase reordering function.

Although FIG. 8 illustrates one example result of a phase reordering function, various changes may be made to FIG. 8. For example, the function may be presented with different values, resulting in a different pattern on the illustration of FIG. 8.

In another embodiment, the above PMI scaling and phase reordering functions may be further smoothed by an unwrapping function. In one example unwrapping function, i_{1,j} for j∈{1,2} is smoothed by

$${i}_{1 , j} ( n ) = \{ \begin{matrix}{i}_{1 , j} ( n ) - {N}_{j} {0}_{j} & if {i}_{1 , j} ( n ) - {i}_{1 , j} ( n - 1 ) \geq \frac{{N}_{j} {0}_{j}}{2} \\ {i}_{1 , j} ( n ) + {N}_{j} {0}_{j} & if {i}_{1 , j} ( n ) - {i}_{1 , j} ( n - 1 ) \leq - \frac{{N}_{j} {0}_{j}}{2} \\ {i}_{1 , j} ( n ) & otherwise\end{matrix}$$

An unwrapping function may be used with or without phase-reordering as described above.

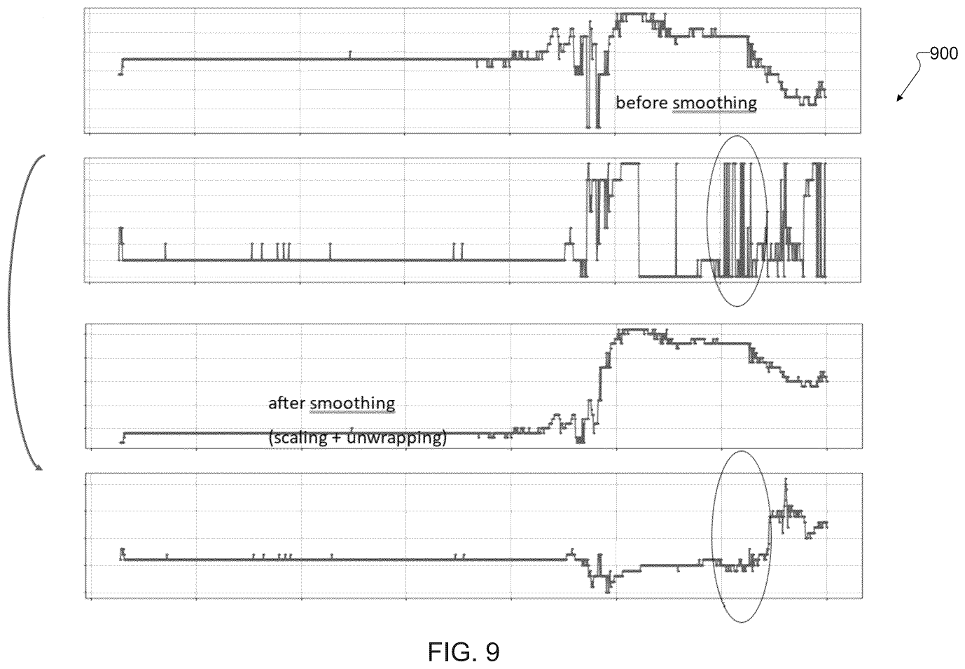

FIG. 9 illustrates an example result of an unwrapping function 900 according to embodiments of this disclosure. The example result of an unwrapping function in FIG. 9 is for illustration only. Other embodiments of an unwrapping function could be used without departing from the scope of this disclosure.

In the example of FIG. 9, both a result from a scaling function similar as previously described, as well as an unwrapping function is shown.

Although FIG. 9 illustrates one example of a result of an unwrapping function, various changes may be made to FIG. 9. For example, the function may be presented with different values, resulting in a different pattern on the illustration of FIG. 9.

In one embodiment, metric dependent prediction algorithms may be implemented for CSI prediction. For instance, in one embodiment for each metric to be predicted, the exact algorithm may be determined by mobility range from a set of available prediction algorithms. For example, simple prediction algorithms may be applied to i_{1,1}, i_{1,2}. CQI and RI, while advanced prediction algorithms may be applied to i_{1,3} and i₂. In one embodiment current CSI configuration may be used to adjust hyper-parameters of prediction algorithms. In another embodiment, Mobility range may also be used to adjust hyper-parameters of prediction algorithms.

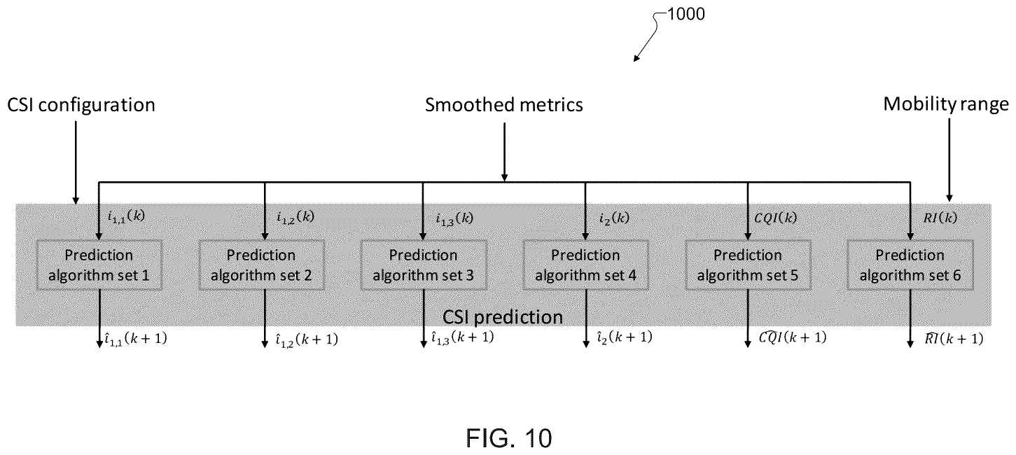

FIG. 10 illustrates a block diagram for an example method of CSI prediction 1000 according to embodiments of this disclosure. The method of CSI prediction in FIG. 10 is for illustration only. Other embodiments of CSI prediction could be used without departing from the scope of this disclosure.

In the example of FIG. 10, a set of prediction algorithms for various CSI metrics are provided corresponding data comprising CSI configuration, smoothed CSI metrics, and mobility range. The various prediction algorithms then provide corresponding CSI predictions for the corresponding CSI metrics.

Although FIG. 10 illustrates one example of CSI prediction, various changes may be made to FIG. 10. For example, CSI prediction may be performed on fewer CSI metrics, CSI prediction may be performed without one of smoothed metrics, CSI configuration, mobility range, etc.

As previously described, a reconfiguration of a CSI configuration may be based on a CSI prediction evaluation (for example, at block 430 of FIG. 4). Performance metrics may be used to determine CSI prediction quality, and may include the mismatch of metrics between prediction and received CSI report (e.g., a degree of mismatch), the difference between channels reconstructed by a predicted/received CSI report, etc.

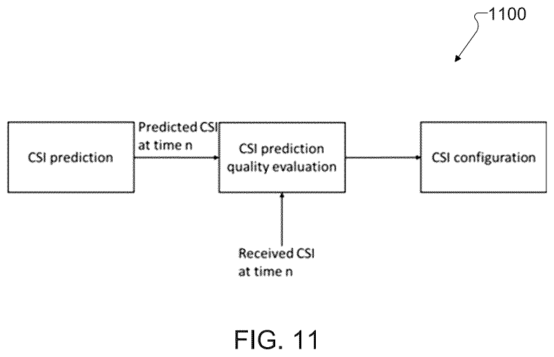

FIG. 11 illustrates a block diagram for an example method 1100 of CSI prediction evaluation according to embodiments of this disclosure. The example method 1100 of CSI prediction evaluation in FIG. 11 is for illustration only. Other embodiments of CSI prediction evaluation could be used without departing from the scope of this disclosure.

In the embodiment of FIG. 11, a predicted CSI (e.g., PMI) for a future time slot n is computed and stored in memory. The predicted CSI is compared with an actual PMI received at the time n. If the CSI prediction quality is sufficiently good, a gNB (for example, BS 102 of FIG. 1) may increase the periodicity of periodic CSI-RS, and/or trigger an aperiodic CSI-RS measurement.

In one embodiment, evaluation criterion for CSI prediction quality may include determining whether the absolute difference between predicted CSI metrics and received CST metrics is less than a pre-determined threshold for at least k out of M received feedback reports. In another embodiment, evaluation criterion for CSI prediction quality may include determining whether a subset of predicted i_{1,1}, i_{1,2}, i_{1,3} and i₂ is matched with at least K₁ out of M₁ received CSI feedback reports. In another embodiment, evaluation criterion for CSI prediction quality may include determining whether the prediction error in terms of mean squared error of reconstructed channel is less than a pre-determined threshold Errₜₕ₂ for at least K₂ out of M₂ received CSI feedback reports. The prediction error may be defined as cosine similarity or mean squared error. In another embodiment, evaluation criterion for CSI: prediction quality may include determining whether the prediction error in terms of mean squared error of reconstructed channel is less than a pre-determined threshold Errₜₕ₃ for at least K₃ out of M₃ received CSI feedback report. The prediction error may be defined as cosine similarity or mean squared error. The parameters Errₜₕ₂, Errₜₕ₃, Kⱼ's and Mⱼ's for j∈{1,2,3} may have multiple choices depending on the current CSI configuration. For example, smaller Errₜₕ₂ and Errₜₕ₃ may have smaller CSI report periodicity and larger

$$\frac{{K}_{j}}{{M}_{j}}$$

may have smaller CSI report periodicity.

In one embodiment, the gNB may trigger AP-CSIRS measurement to get PMI feedback to compare with the predicted value. In one embodiment, wideband PMI values may be fed back and compared. In another embodiment, subband PMI may be configured and fed back. In this case, a total channel error (i.e., a reconstructed full band channel based on predicted PMI is compared with the reconstructed channel matrix from actual reported PMI) may be computed to determine the prediction accuracy.

Although FIG. 11 illustrates one example of a method for CSI prediction evaluation, various changes may be made to FIG. 11. For example, the CSI metric may change, the prediction time may change, etc.

In one embodiment, CSI reconfiguration may comprise periodicity adaptation. For example, larger periodicity may be used in circumstances where prediction quality is evaluated as acceptable for M₁ consecutive CSI reports, while smaller periodicity may be used in circumstances where prediction quality is evaluated as unacceptable for M₂ consecutive CSI reports. In another example, larger periodicity may be used in circumstances where prediction quality is evaluated as acceptable for M₁ out of L₁ CSI reports, while smaller periodicity may be used in circumstances prediction quality is evaluated as unacceptable for M₂ out of L₂ CSI reports. For smaller CSI feedback periodicity, Mⱼ is larger and

$$\frac{{M}_{j}}{{L}_{j}}$$

is larger for j∈{1,2}. For higher values of CQI and RI obtained from a received CSI report, Mⱼ is larger and

$$\frac{{M}_{j}}{{L}_{j}}$$

is larger for j∈{1,2}.

In one embodiment, CSI reconfiguration may comprise triggering an aperiodic CSI report: For example, an aperiodic CSI report may be triggered to evaluate prediction quality given a large periodicity of CSI feedback report.

As previously described, an apparatus such as BS 102 of FIG. 1 may perform a mobility range classification such as at block 415 of FIG. 4. In one embodiment, the mobility range classification may include a speed range classification.

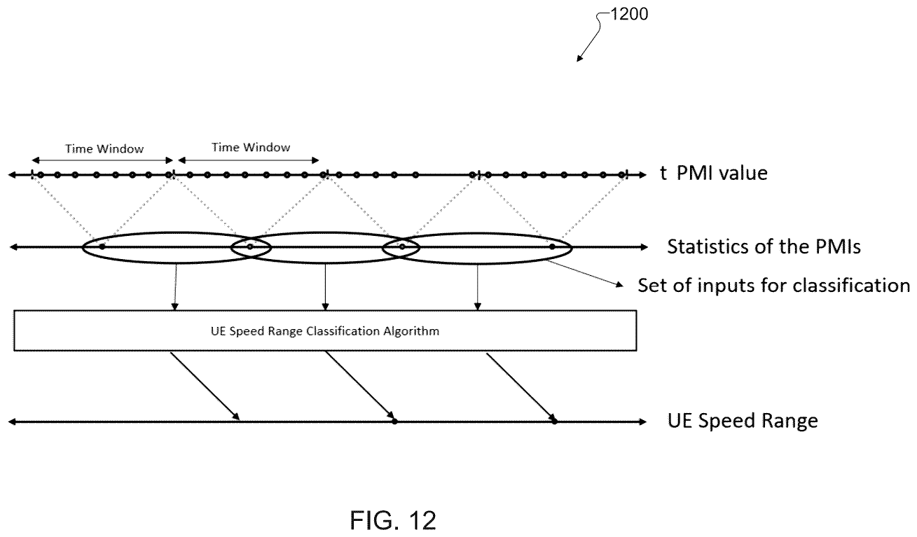

FIG. 12 illustrates an example method for UE speed range classification 1200 according to embodiments of this disclosure. The example UE speed range classification in FIG. 12 is for illustration only. Other embodiments of UE mobility range classification could be used without departing from the scope of this disclosure.

In the example of FIG. 12, a time diagram for the UE speed mobility range classification based on the PMI values is shown. The statistics of a CSI report content over a time window is computed. This time window is shifted over time to generate samples for a mobility prediction by a) overlapping or b) non-overlapping way. These statistics may be mean, variance/std, maximum, minimum, absolute difference of maximum and minimum, number of unique values. These statistics may then be collected together, over a larger time window to classify the UE speed range. UE speed range may be determined as static (e.g., velocity<1 km/h) and mobile (e.g., velocity>1 km/h). Alternatively, multiple speed ranges may be taken as the objective of the classification. For example, three level UE speed range classifications with static (velocity<1), low-speed (1<velocity<40), and high-speed (40<velocity) may be targeted. With this given a number of latest statistics of time windows, the classification algorithm may return a prediction for the UE speed range. As the algorithm, different classification methods including decision trees, SVM, gradient boosting trees, neural networks may be adopted. In one example, a low complexity model gradient boosting tree may be adopted. In another example, a high complexity gradient boosting tree model may be adopted.

Although FIG. 12 illustrates one example of a UE speed range classification, various changes may be made to FIG. 12. For example, the time window may change, the number of speed ranges may change, etc.

As previously described, mobility range classification may be based on smoothed metrics such as in block 415 of FIG. 4. In one embodiment smoothed metrics may be used to generate features for mobility range classification.

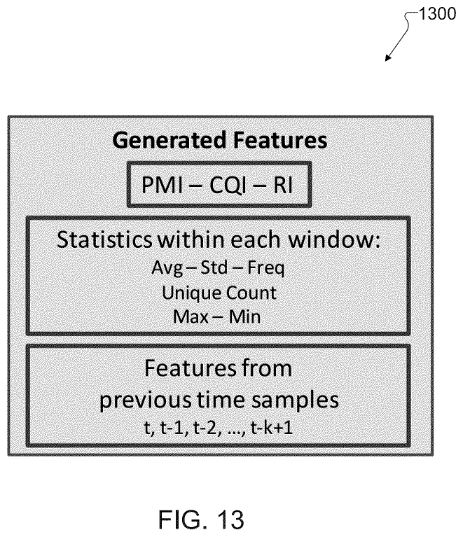

FIG. 13 illustrates an example of generated features 1300 for mobility range classification according to embodiments of this disclosure. The example generated features in FIG. 13 is for illustration only. Other embodiments of mobility range classification generated could be used without departing from the scope of this disclosure.

In the example of FIG. 13, the generated features may be derived from CSI such as PMI, CQI, and RI. They may also be derived from statistics within each window, and from previous time samples.

In one embodiment, smoothed PMI components (i_{1,1}, i_{1,2}, i_{1,3} and i₂), CQI and RI may be used to derive features for mobility range classification. In one embodiment, a window length k may depend on current CSI configuration, and CQI and RI. For example, smaller values of CQI and RI may require larger k to mitigate the impact of noise. In one embodiment, classification model selection may depend on a current CSI configuration. For example, mobility range be either static vs. mobile or have multiple ranges (e.g., 0 km/h 1˜5 km/h, 5 km/h˜15 km/h, >15 km/h). In another example, one classification model may be designated to a single CSI feedback periodicity. In another embodiment, the classification results may be used to adapt transmission configurations (for example at block 435 of FIG. 4). For example, more frequent reference signals may be sent from a gNB given a UE with higher UE mobility. In another example, a more sophisticated link adaptation algorithm may be used for a UE with high mobility.

Although FIG. 13 illustrates one example of a generated features for mobility range classification, various changes may be made to FIG. 13. For example, certain statistics may be added or omitted, the number of time samples may vary, etc.

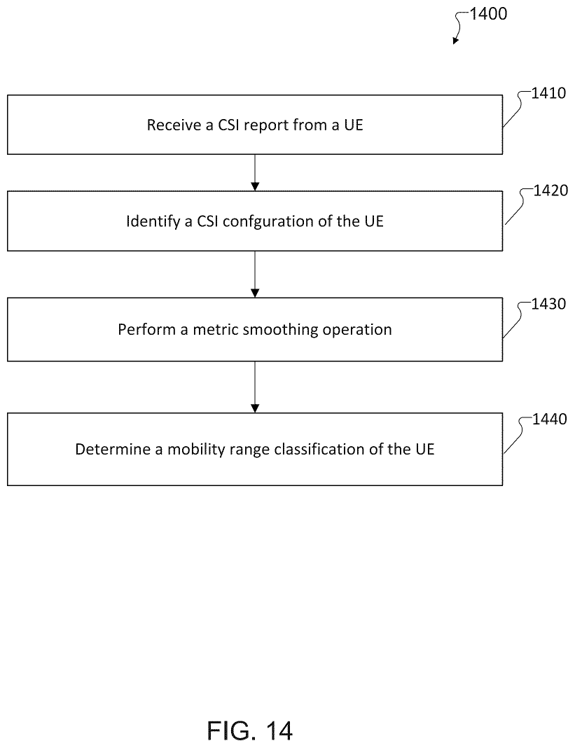

FIG. 14 illustrates an example method 1400 of mobility classification and CSI prediction according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of mobility classification and CSI prediction could be used without departing from the scope of this disclosure.

As illustrated in FIG. 14, the method 1400 begins at step 1410. At step 1410, a CSI report is received from a UE. In one embodiment, the CSI report comprises a PMI, a CQI, and an RI. At step 1420, a CSI configuration for the UE is identified. At step 1430, a metric smoothing operation is performed. In one embodiment, the metric smoothing operation is performed on a PMI, resulting in a smoothed PMI. In one embodiment, the metric smoothing operation comprises a scaling function based on an RI and a DFT vector length. At step 1440, a mobility range classification of the UE is determined. In one embodiment, the mobility range classification is based on a smoothed PMI. In one embodiment, the mobility range classification is based on metrics in a CSI report. In one embodiment, the mobility range is based on a CSI configuration.

Although FIG. 14 illustrates one example of a method 1400 of mobility classification and CSI prediction, various changes may be made to FIG. 14. For example, while shown as a series of steps, various steps in FIG. 14 could overlap, occur in parallel, occur in a different order, or occur any number of times.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A base station (BS) comprising:
a transceiver configured to receive, from a user equipment (UE), a channel state information (CSI) report comprising a precoding matrix indicator (PMI), a channel quality information (CQI), and a rank indicator (RI); and
a processor operably coupled to the transceiver, the processor configured to:
identify a CSI configuration of the UE;
perform a metric smoothing operation on the PMI resulting in a smoothed PMI, wherein the metric smoothing operation comprises a scaling function based on the RI and a discrete Fourier transform (DFT) vector length; and
determine a mobility range classification of the UE based on the smoothed PMI, other metrics in the CSI report, and the CSI configuration.

2. The BS of claim 1, wherein the metric smoothing operation further comprises at least one of a reordering function and an unwrapping function.

3. The BS of claim 1, wherein to determine the mobility range classification, the processor is further configured to:
derive a first set of mobility range classification features based on the smoothed PMI;
derive a second set of mobility range classification features based on the RI;
derive a third set of mobility range classification features based on the CQI;
select a classification model based on the CSI configuration; and
determine the mobility range classification based on the first set of mobility range classification features, the second set of mobility range classification features, the third set of mobility range classification features, and the classification model.

4. The BS of claim 1, wherein the processor is further configured to:
generate a CSI prediction based on the CSI configuration, the smoothed PMI, and the mobility range classification; and
perform a downlink (DL) transmission based on the CSI prediction.

5. The BS of claim 4, wherein to generate the CSI prediction, the processor is further configured to:
determine a prediction algorithm based on the mobility range classification;
adjust parameters associated with the prediction algorithm based on the CSI configuration; and
generate the CSI prediction based on the prediction algorithm and the adjusted parameters.

6. The BS of claim 4, wherein the processor is further configured to:
generate a CSI prediction evaluation based on a degree of mismatch between CSI associated with the CSI report and the CSI prediction; and
modify the CSI configuration based on the CSI prediction evaluation.

7. The BS of claim 6, wherein to modify the CSI configuration, the processor is further configured to at least one of:
change a periodicity configuration for transmission of the CSI report; and
trigger an aperiodic CSI report transmission.

8. A method of operating a base station (BS), the method comprising:
receiving, from a user equipment (UE), a channel state information (CSI) report comprising a precoding matrix indicator (PMI), a channel quality information (CQI), and a rank indicator (RI);
identifying a CSI configuration of the UE;
performing a metric smoothing operation on the PMI resulting in a smoothed PMI, wherein the metric smoothing operation comprises a scaling function based on the RI and a discrete Fourier transform (DFT) vector length; and
determining a mobility range classification of the UE based on the smoothed PMI, other metrics in the CSI report, and the CSI configuration.

9. The method of claim 8, wherein the metric smoothing operation further comprises at least one of a reordering function and an unwrapping function.

10. The method of claim 8, wherein determining the mobility range classification comprises:
deriving a first set of mobility range classification features based on the smoothed PMI;
deriving a second set of mobility range classification features based on the RI;
deriving a third set of mobility range classification features based on the CQI;
selecting a classification model based on the CSI configuration; and
determining the mobility range classification based on the first set of mobility range classification features, the second set of mobility range classification features, the third set of mobility range classification features, and the classification model.

11. The method of claim 8, further comprising:
generating a CSI prediction based on the CSI configuration, the smoothed PMI, and the mobility range classification; and
performing a downlink (DL) transmission based on the CSI prediction.

12. The method of claim 11, wherein generating the CSI prediction comprises:
determining a prediction algorithm based on the mobility range classification;
adjusting parameters associated with the prediction algorithm based on the CSI configuration; and
generating the CSI prediction based on the prediction algorithm and the adjusted parameters.

13. The method of claim 11, further comprising:
generating a CSI prediction evaluation based on a degree of mismatch between CSI associated with the CSI report and the CSI prediction; and
modifying the CSI configuration based on the CSI prediction evaluation.

14. The method of claim 13, wherein modifying the CSI configuration comprises at least one of:
changing a periodicity configuration for transmission of the CSI report; and
triggering an aperiodic CSI report transmission.

15. A non-transitory computer readable medium embodying a computer program, the computer program comprising program code that, when executed by a processor of a base station (BS), causes the BS to:
receive, from a user equipment (UE), a channel state information (CSI) report comprising a precoding matrix indicator (PMI), a channel quality information (CQI), and a rank indicator (RI);
identify a CSI configuration of the UE;
perform a metric smoothing operation on the PMI resulting in a smoothed PMI, wherein the metric smoothing operation comprises a scaling function based on the RI and a discrete Fourier transform (DFT) vector length; and
determine a mobility range classification of the UE based on the smoothed PMI, other metrics in the CSI report, and the CSI configuration.

16. The non-transitory computer readable medium of claim 15, wherein the metric smoothing operation further comprises at least one of a reordering function and an unwrapping function.

17. The non-transitory computer readable medium of claim 15, wherein to determine the mobility range classification, the computer program further comprises program code that, when executed by the processor, causes the BS to:
derive a first set of mobility range classification features based on the smoothed PMI;
derive a second set of mobility range classification features based on the RI;
derive a third set of mobility range classification features based on the CQI;
select a classification model based on the CSI configuration; and
determine the mobility range classification based on the first set of mobility range classification features, the second set of mobility range classification features, the third set of mobility range classification features, and the classification model.

18. The non-transitory computer readable medium of claim 15, wherein the computer program further comprises program code that, when executed by the processor, causes the BS to:
generate a CSI prediction based on the CSI configuration, the smoothed PMI, and the mobility range classification; and
perform a downlink (DL) transmission based on the CSI prediction.

19. The non-transitory computer readable medium of claim 18, wherein to generate the CSI prediction, the computer program further comprises program code that, when executed by the processor, causes the BS to:
determine a prediction algorithm based on the mobility range classification;
adjust parameters associated with the prediction algorithm based on the CSI configuration; and
generate the CSI prediction based on the prediction algorithm and the adjusted parameters.

20. The non-transitory computer readable medium of claim 18, wherein the computer program further comprises program code that, when executed by the processor, causes the BS to:
generate a CSI prediction evaluation based on a degree of mismatch between CSI associated with the CSI report and the CSI prediction; and
modify the CSI configuration based on the CSI prediction evaluation, wherein modifying the CSI configuration comprises at least one of:
changing a periodicity configuration for transmission of the CSI report; and
triggering an aperiodic CSI report transmission.
